(19) United States
(12) Patent Application Publication
(10) Pub. No.: US 2010/0138501 A1
(43) Pub. Date: Jun. 3, 2010

(54) END-TO-END VALIDATION IN A PUSH ENVIRONMENT

(75) Inventors: Nathaniel T. Clinton, Sammamish, WA (US); Adam Sapek, Redmond, WA (US); Johannes Klein, Sammamish, WA (US); Farookh Mohammed, Woodinville, WA (US); Rashid Qureshi, Redmond, WA (US); Shai Herzog, Bellevue, WA (US); Eric David Deily, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/327,484

(22) Filed: Dec. 3, 2008

(51) Int. Cl. G06F 15/16

(52) U.S. Cl. 709/206; 709/227; 709/224

(57) ABSTRACT

In a push environment having a communication path along which a service provides messages to a computing device via a gateway, an inactivity timeout value and a registration timeout value enable the computing device to detect failures in the communication path. An application executing on the computing device registers an application endpoint with the gateway. The application separately subscribes to the service to receive the messages. If there is inactivity in accordance with the inactivity timeout value, the application de-registers and re-registers with the gateway, and unsubscribes and re-subscribes with the service.

### BACKGROUND

Mobile devices receive data asynchronously from a variety of sources. The data is pushed to the mobile devices and includes updates to online user profiles (e.g., at social networking web sites), weather and traffic conditions, and notifications such as package delivery notifications. Existing systems include a plurality of services sending the data through a plurality of gateways to the mobile devices. However, existing systems fail to provide a mechanism in the push environment for detecting failures along the communication path to the mobile devices.

### SUMMARY

Embodiments of the invention provide end-to-end validation along a communication path involving a service, a gateway, and a computing device. A component executing on the computing device receives a request from an application to register an application endpoint. The component registers the application endpoint with the gateway responsive to the received request. The application subscribes to the service. The gateway defines an inactivity timeout value for the application endpoint, and monitors the communication path. When the component receives a notification from the gateway of expiration of the inactivity timeout value, the component notifies the application to re-register with the gateway and to re-subscribe with the service.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a push environment having a communication path from a service to a gateway to a computing device.

FIG. 2 is an exemplary sequence diagram illustrating application endpoint registration and subscription.

FIG. 3 is an exemplary flow chart illustrating operation of failure detection and resolution.

FIG. 4 is an exemplary sequence diagram illustrating detection of a gateway failure.

FIG. 5 is an exemplary sequence diagram illustrating detection of a loss of connectivity between the application and the gateway.

FIG. 6 is an exemplary sequence diagram illustrating detection of a computing device failure.

FIG. 7 is an exemplary sequence diagram illustrating detection of a failure of the service.

FIG. 8 is an exemplary block diagram illustrating a computing device storing computer-executable components for implementing failure detection in a push environment.

Corresponding reference characters indicate corresponding parts throughout the drawings.

### DETAILED DESCRIPTION

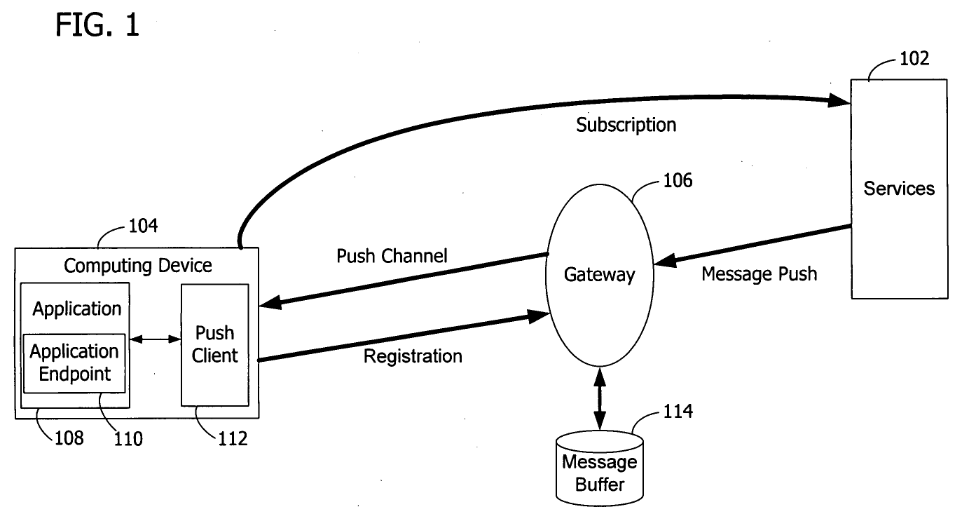

Referring to the figures, embodiments of the disclosure enable end-to-end validation in a push environment. In an exemplary push environment such as illustrated in FIG. 1, one or more services 102 push messages to at least one gateway 106. The gateway 106 delivers the messages to a computing device 104. The message flow is unidirectional in that the messages are sent by the services 102 to an application 108 via the gateway 106. In the push environment, detecting a failure along the communication path is difficult. Embodiments of the invention provide an inactivity timeout value and a registration timeout value. These timeout values are used to determine when a failure has occurred along the communication path. The computing device 104 may then re-establish the connection.

The service 102 is any type of service that pushes content to the computing device 104. For example, the service 102 may include an email server, a sales server, a web server, a database server, a file server, a print server, or any other kind of server.

The messages include any kind of information or data such as text messages, electronic mail messages, voice messages, images, and video. The computing device 104 can be a mobile telephone, a portable media player, a smartphone, a personal digital assistant, an information appliance, a personal communicator, a handheld game console, an ultra-mobile personal computer, a handheld television, or any other type of electronic device that is able to communicate with another system through a network.

In some embodiment, there are a plurality of services 102, a plurality of gateways 106, and a plurality of computing devices 104. The computing device 104 has at least one application 108 executing thereon. The application 108 has one or more application endpoints 110 for receipt of the messages. The application endpoints 110 are associated with, for example, a mail application program, an instant messaging application program, or a web browser. The computing device 104 has at least one push component or pipe component for interfacing between the gateway 106 and the application 108. In some embodiments, there is one push client 112 for each application 108. In other embodiments, there is one push client 112 for all the applications 108 executing on the computing device 104.

In the example of FIG. 1, the gateway 106 has access to a message buffer 114. The message buffer 114 stores messages received from the services 102. For example, the gateway 106 may queue messages until the messages may be delivered to the computing device 104. In this manner, the messages are persisted during computing device 104 offline periods. In addition, the computing device 104 may move between gateways 106 without losing queued messages. In some embodiments, the message buffer 114 is shared by multiple instances of the gateway 106.

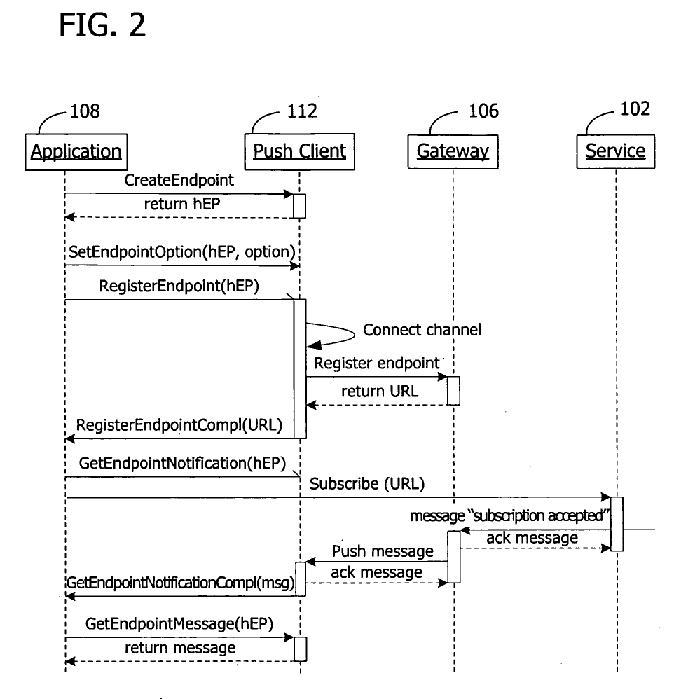

Referring next to FIG. 2, an exemplary sequence diagram illustrates application endpoint 110 registration and subscription. Registration includes establishing a bi-directional communication link between the computing device 104 and the gateway 106 such that the gateway 106 forwards messages from the services 102 to the computing device 104. In the example of FIG. 2, the application 108 creates an endpoint with the push client 112. The push client 112 registers the created endpoint with the gateway 106.

In some embodiments, registration includes receiving, by the push client 112, a request from the application 108 to register the application endpoint 110 (e.g., RegisterEndpoint). The push client 112 identifies one or more channels available for communication and selects one of the identified channels. The push client 112 works with the gateway 106 to define an object, address space, or other globally unique identifier such as an endpoint uniform resource identifier (URI) for the selected channel, and provides the defined object to the application 108. In some examples, the channel is selected based on one or more policy settings for the application 108. Alternatively, the gateway 106 provides the object to the push client 112 to give to the application 108.

The push client 112 registers the application endpoint 110 with the gateway 106, and provides the object to the application 108. The application 108 uses the object to subscribe with the service 102. Additionally, the application 108 or the push client 112 defines a registration timeout value. The registration timeout value includes, for example, a maximum time in seconds for a message to be received by the application 108 after requesting registration from the push client 112. The push client 112, or the application 108, calculates an elapsed time since, for example, the registration request was submitted to the push client 112. If the elapsed time exceeds or violates the registration timeout value before a first message is received by the application 108, the application 108 is notified of a registration failure or timeout condition. Responsive to the notification, the application 108 de-registers and unsubscribes, then subsequently re-registers and subscribes. For example, the application 108 may re-register with another gateway 106.

Responsive to the registration, the application 108 receives the object such as a uniform resource locator (URL) or other address space from the gateway 106. The object identifies the gateway 106 and the computing device 104. The computing device 104 subscribes to receive messages from the service 102. This subscription occurs separate from, or independent, exclusive, or outside of the gateway 106. In other words, the subscription occurs directly between the application 108 and the service 102 without involvement of the gateway 106. During subscription, the application 108 communicates the object to the service 102 and requests that the messages be sent to the application 108 via the object.

The object may be any type of identifier that can identify the gateway 106. In one example, the URL has the following exemplary format: {Gateway Domain Name Server Name}/{Computing Device Name}/{Application Name}/{Extension}. The first portion “Gateway Domain Name Server Name” is the domain name of the gateway 106 in the Domain Name System (DNS). The first portion tells the service 102 where to send the message (e.g. to the gateway 106). The second portion “Client Name” tells the gateway 106 which computing device 104 to receive the message. The third portion “Application Name” tells the computing device 104 which application 108 executing on the computing device 104 to receive it. The fourth portion “Extension” is an extension of the application 108. The “Extension” is optional. One particular example of the object includes PushGW.xyz.com/Client 123/App456/doc.

After or during registration, the application 108 or gateway 106 defines an inactivity timeout value for the application endpoint 110. The inactivity timeout value represents a maximum time in seconds between receipt of messages from the service 102. In an example, the application 108 provides the inactivity timeout value to the gateway 106. The gateway 106 monitors the communication path. If there is no activity by the gateway 106 for that application endpoint 110 after the inactivity timeout value expires, the gateway 106 notifies the push client 112 or the application 108 of the timeout condition. In some embodiments, to avoid the timeout expiring absent of communication failure, the service 102 sends periodic “heartbeat” messages to the gateway 106. Such messages are not delivered to the application endpoint 110 (e.g., to save device resources) and serve to confirm liveliness of the application endpoint 110. In such embodiments, the service 102 knows the inactivity timeout value so that the service 102 can time the heartbeat messages to be more frequent than the timeout. The service 102 may learn the inactivity timeout value as part of subscription.

Exemplary application programming interfaces for implementing registration and other functions are described in Appendix A.

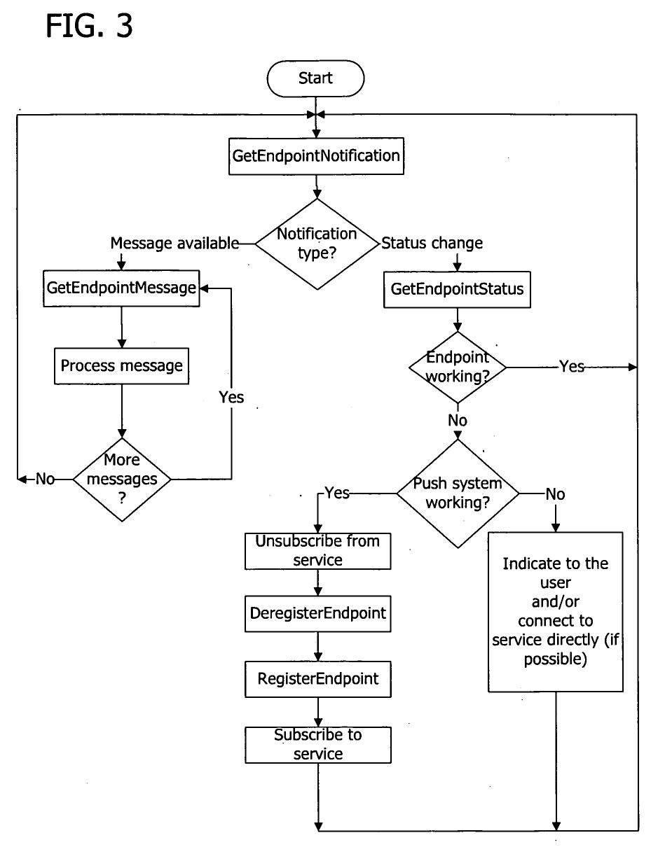

Referring next to FIG. 3, an exemplary flow chart illustrates operation of failure detection and resolution by the application 108 in concert with the push client 112. The application 108 receives messages when the messages become available at the push client 112, so long as the endpoint is working. A non-working endpoint is detected using the timeouts (e.g., registration and inactivity) as described herein. In a non-working push system, there is not any channel to any known gateway working. If the endpoint is not working and the push system is not working, the application 108 displays an error to the user or attempts to connect directly to the service 102. If the endpoint is not working yet the push system is working, the application 108 unsubscribes from the service 102, de-registers the application endpoint 110, re-registers a new application endpoint 110, and re-subscribes to the service 102.

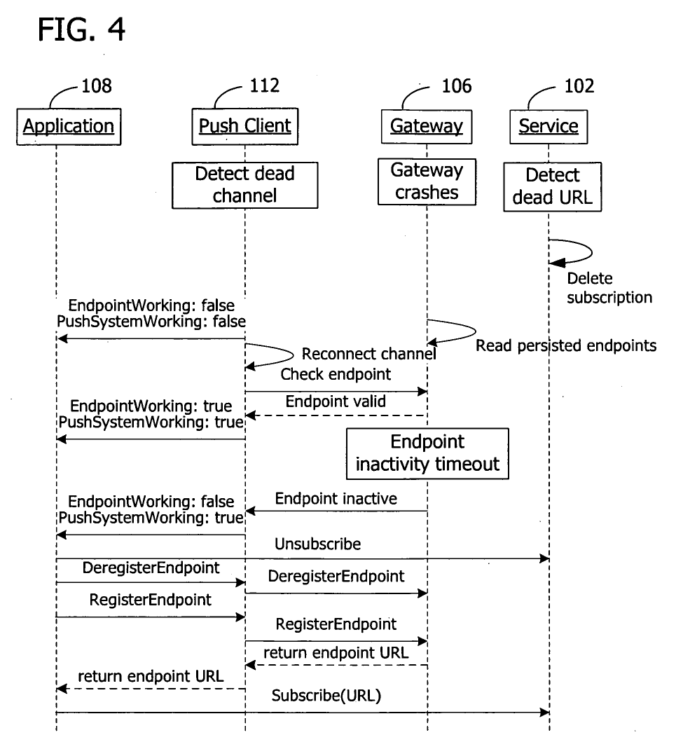

Referring next to FIG. 4, an exemplary sequence diagram illustrates detection of a gateway 106 failure. In the example of FIG. 4, one of the gateways 106 has failed or crashed. When the gateway 106 recovers, or another gateway 106 takes over, the inactivity timeout value has expired because the gateway 106 missed messages from the service 102 when the gateway 106 was offline after the crash. The gateway 106 notifies the push client 112, which prompts the application 108 to unsubscribe from the service 102, de-register the application endpoint 110, re-register the application endpoint 110, and re-subscribe to the service 102.

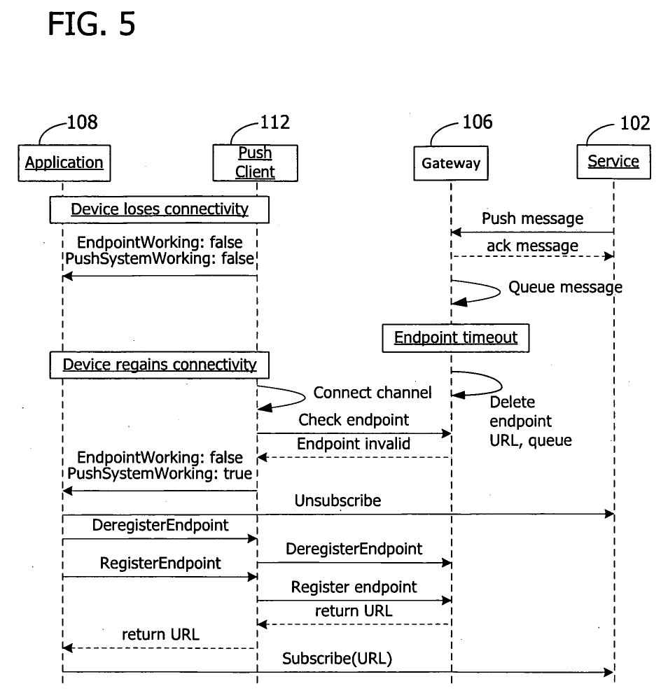

Referring next to FIG. 5, an exemplary sequence diagram illustrates detection of a loss of connectivity between the application 108 and the gateway 106. A connectivity problem lasting more than a channel timeout value may result in a state of the application endpoint 110 being removed from the gateway 106 and the object being invalidated. In this example, the push client 112 queries the status of the registered application endpoint 110. Because the state of the application endpoint 110 has been removed, the gateway 106 informs the push client 112 that the endpoint is invalid. Subsequently, the application 108 re-registers the application endpoint 110 and notifies the service 102 about the re-registered application endpoint 110.

In some embodiments, the channel timeout value detects whether the device 104 is interested in the registered application endpoint 110. If the device 104 gets disconnected (e.g., due to a general packet radio service disruption), the channel/endpoint is still maintained on the gateway 106, provided the push client 112 re-establishes the connection within the channel timeout interval. However, if the push client 112 unregisters the application endpoint 110 and the request is not delivered or processed by the gateway 106, this mechanism allows the gateway 106 to clean up the state (e.g., remove the channel and associated queue) after the channel timeout value interval and conserve memory.

If the channel timeout value is longer than the inactivity timeout value, the device 104 may be offline for a longer period of time (e.g., up to the channel timeout value) and the gateway 106 queues messages to the device 104 in the buffer. However, the application 108 does not learn about the potential failure of communication for a longer period of time.

If the channel timeout value is set to the same value as the inactivity timeout value, the push client 112 provides a guarantee to the application 108 that if any communication failure (e.g., be it on the channel between the device 104 and the gateway 106 or between the gateway 106 and the service 102) lasts more than the channel timeout value, the application 108 is notified and can initiate a recover sequence.

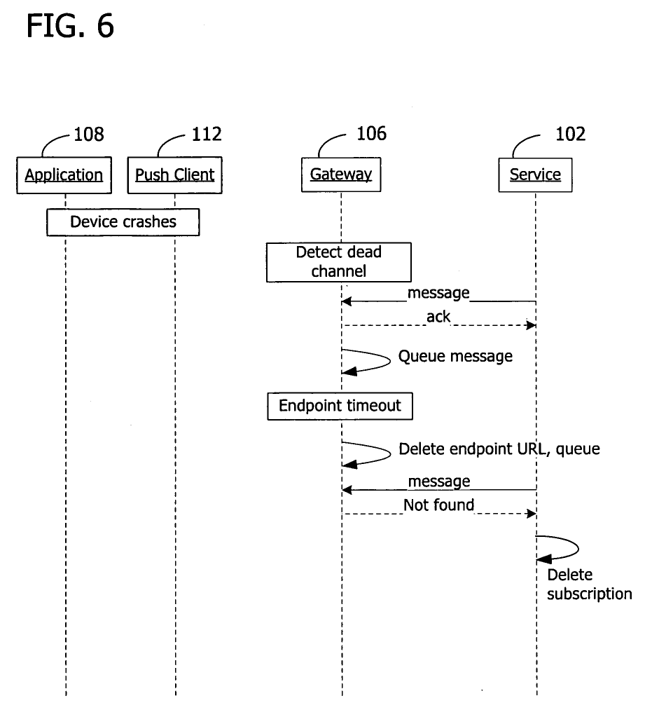

Referring next to FIG. 6, an exemplary sequence diagram illustrates detection of a computing device failure. In the example of FIG. 6, the push client 112 does not receive messages from the gateway 106. After the expiration of the channel timeout value, the application endpoint 110 and state are deleted.

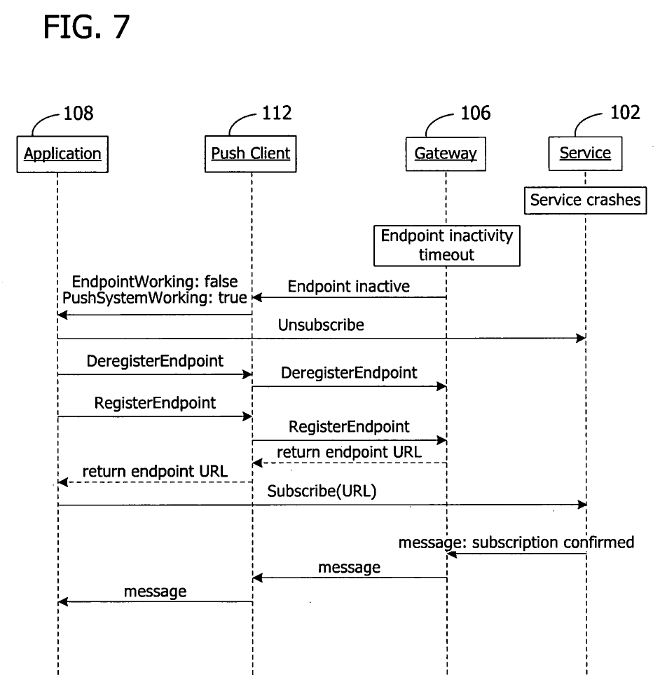

Referring next to FIG. 7, an exemplary sequence diagram illustrates detection of a failure of the service 102. After the expiration of the inactivity timeout value, the gateway 106 notifies the push client 112 of the service 102 failure. Subsequently, the application 108 unsubscribes from the service 102, de-registers with the gateway 106, re-registers the application endpoint 110, and re-subscribes to the service 102.

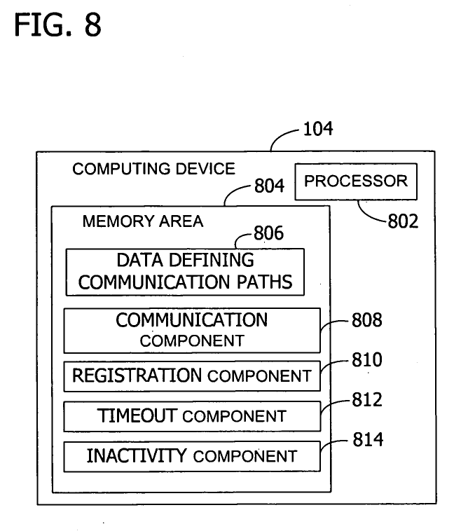

Referring next to FIG. 8, an exemplary block diagram illustrates the computing device 104 storing computer-executable components for implementing failure detection in a push environment. In the example of FIG. 8, the computing device 104 includes a processor 802 and a memory area 804. The memory area 804 stores data 806 defining one or more communication paths between the computing device 104 and the service 102. The memory area 804 further stores a communication component 808, a registration component 810, a timeout component 812, and an inactivity component 814. The communication component 808 interfaces, or facilitates data exchange, between the computing device 104 and the gateway 106. The registration component 810 registers the application endpoint 110 with the gateway 106. The timeout component 812 monitors the registration by the registration component 810. The timeout component 812 notifies the application 108 of a timeout condition after a predefined period of inactivity (e.g., based on the registration timeout value). After a successful registration, the inactivity component 814 receives a notice of inactivity from the gateway 106 if the inactivity timeout value maintained by the gateway 106 expires (e.g., if the service 102 crashed). The inactivity component 814 notifies the application 108 of the inactivity responsive to the received notice of inactivity. Responsive to the notification from the inactivity component 814, the application 108 re-registers the application endpoint 110 and re-subscribes with the service 102.

Aspects of the invention transform a general-purpose computer into a special-purpose computing device when configured to execute the instructions described herein.

While aspects of the invention are described with reference to the computing device 104 being a mobile computing device such as a mobile telephone, embodiments of the invention are operable with any computing device. For example, aspects of the invention are operable with devices such as laptop computers, gaming consoles, hand-held or vehicle-mounted navigation devices, portable music players, and other devices.

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The embodiments illustrated and described herein as well as embodiments not specifically described herein but within the scope of aspects of the invention constitute exemplary means for identifying a communication failure based on the inactivity timeout value, and exemplary means for re-establishing the communication path responsive to expiration of the inactivity timeout value.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

Exemplary application programming interfaces (API) are described below.

### CreateEndpoint

Creates object representing endpoint. Until the endpoint is registered, no communication with gateway is established and no state on the gateway is created.

[out] hEndpoint

### SetEndpointOption

Sets endpoint settings. The API may be called at any endpoint state, however since most options apply only to active endpoints, setting may not take effect until endpoint is registered. All options have reasonable defaults that may differ for different channels/gateways.

[in] hEndpoint
[in] Option Type
[in] blobOption—a structure containing option parameters as specified in the table below.

TABLE A1
Option Parameters.

| Option type | Description | Parameters |
|---|---|---|
| SUPRESS_MESSAGE | This option allows applications to | unsigned Bitmap-32 bit bitmap |
| | suppress messages based on | specifying which classes of messages to |
| | message class. Suppressed | be rejected by the gateway. Note that |
| | messages are dropped by the | class 0 used for idle messages from |
| | gateway. The setting can be | Application Server to gateway and is |
| | changed at any time and takes | suppressed. |
| | effect immediately of the endpoint | Default is 0 (all messages are accepted). |
| | is active. | |
| FRIENDLY_NAME | This option can be used by the | string Name-human readable name of |
| | gateway for logging, reports, | the endpoint |
| | troubleshooting, etc. | Default is generated by Push Client (e.g., |
| | The setting takes effect when the | it may be derived from the friendly name |
| | endpoint is registered. | of the application account, on other OS |
| | | versions it can be name of the |
| | | executable). |
| LIFETIME | Specifies how long the gateway | unsigned Lifetime-time in seconds |
| | keeps the endpoint when the | Default is selected by the channel. |
| | device is unreachable. This is a | |
| | hint from application and | |
| | channel/gateway may override it. | |
| | The setting takes effect when the | |
| | endpoint is registered. | |
| DELIVERY_PARAMS | Allows applications to fine tune | MessageClass-specifies message class |
| | delivery parameters for different | for which the parameters are set. |
| | message classes. Most | unsigned Delay-maximum batching |
| | applications will not change these | delay, in second, for messages in |
| | settings. The settings are treated | specified class. |
| | as hints and can be ignored by the | unsigned Burst-maximum burst for |
| | channel/gateway or overridden by | messages in specified class. |
| | device policy. | Defaults are set by the channel such that |
| | Device policy may limit valid | classes 1-9 will provide real time |
| | ranges for each parameter | delivery, 10-21 will be delayed by |
| | separately for each message class. | several minutes and 22-31 may be |
| | | delayed by up to an hour. |

RegisterEndpoint [async]

Establishes communication channel between the device and the gateway, allocates endpoint state on the gateway and returns endpoint URL to the appliation. The URL is generated by the channel/gateway.

Registered endpoint does not guarantee end-to-end from service to device. If service is not able to reach the device using the endpoint, application may unregister and register the endpoint. The Push Client will first try to use a different gateway and then different channel if the previous one was unreachable.

The API is asynchronous and the call returns immediately as pending. The Push Client performs registration in the background and notifies application when the process completes. The application can then obtain the endpoint URL. Application may cancel pending registrations at any time by calling UnregisterEndpoint or CloseEndpoint.

The call fails with ALREADY_REGISTERED error if the endpoint is already registered or RegisterEndpoint or RegisterStaticEndpoint call is pending.

[in] hEndpoint

[in, optional] strApplicationServer—name of Application Server that is authorized to send messages to the endpoint. Application Server will need to authenticate using SSL mutual authentication in order to send a message to the endpoint.

If not specified, endpoint will not require Application Server to authenticate. If endpoints w/o authentication are not supported, the registration will fail

[in, optional] nEndToEnd Verification Timeout—maximum time in seconds for the first message to arrive to the endpoint. If initial message does not arrive within specified time the endpoint is considered invalid and application is notified. 0 means no timeout. If not specified, default is 120 seconds.

[in] nInactivity Timeout—maximum time in seconds between massages. If endpoint is inactive for longer than the specified time the endpoint is considered invalid and application is notified. 0 means no timeout. If not specified, default is 0.

[out] strEndpointURL—URL representing registered endpoints. If strApplicationServer was not specified then the endpoint does not require authentication and the URL itself includes the authorization ticket and MUST NOT be transmitted in the clear.

RegisterStaticEndpoint [async]

Establishes communication channel between the device and the gateway and registers device with a static endpoint. Unlike RegisterEndpoint, this API does not return endpoint URL. Static endpoints URLs are predictable (or discoverable through the gateway) and thus do not need to be communicated by the application to the Application Server.

Static endpoints do not support initialization and inactivity timeouts. Lifetime of static endpoint is fully controlled by the channel/gateway. Application will be notified when endpoint is deleted by the gateway.

The API is asynchronous and the call returns immediately as pending. The Push Client performs registration in the background and notifies application when the process completes. Application may cancel pending registrations at any time by calling UnregisterEndpoint or CloseEndpoint.

The call fails with ALREADY_REGISTERED error if the endpoint is already registered or RegisterEndpoint or RegisterStaticEndpoint call is pending.

[in] hEndpoint

[in] strChannel—identifies channel used to register the static endpoint. Static endpoints can be only registered on a specific channel and are discoverable through the gateway on which they are registered.

[in] strApplication—unique identifier of application. If a static endpoint with this identifier is already registered on the device, the call will fail.

### DeregisterEndpoint

Deregisters the endpoint on the gateway and dereferences the channel connection. The API is synchronous and call completes immediately although the actual deregistration with the gateway will be completed asynchronously (e.g. in particular when device does not have connectivity with the gateway, deregistration will be pending until connection is reestablished). Application is not notified about completion of deregistration. Pending deregistration is not associated with the local endpoint object (hEndpoint) and the endpoint can be reregistered immediately after the API returns. The Push Client service must be able to handle several pending deregistration requests however it may drop deregistration requests that cannot be completed after some time since the gateway will independently cleanup endpoint state for an unreachable device anyways.

[in] hEndpoint

### CloseEndpoint

Performs DeregisterEndpoint, if necessary, and destroys the local endpoint object.

[in] hEndpoint
GetEndpointNotification [async]

Returns notification associated with the endpoint when available. There are two types of notifications:

1. MESSAGE—push message(s) are queued and available for retrieval using GetEndpointMessage.

2. STATUS—endpoint status has changed since the last time application checked it using GetEndpointStatus.

The API is asynchronous. The call returns immediately as pending and application is notified of completion when a notification is available. After processing the notification application calls GetEndpointNotification again. Only one outstanding call to GetEndpointNotification is allowed; the API will fail if there is already a pending call.

[in] hEndpoint

[in] dwNotificationsRequested—bitmap indicating which notification types (MESSAGE and/or STATUS) the application is interested in.

[out] dwNotificationsAvailable—bitmap indicating which notifications are available.

### GetEndpointMessage

Retrieves message from local endpoint queue. If there are no messages in the queue, the API returns appropriate error code.

[in] hEndpoint
[out] blobMessage

### GetEndpointStatus

Returns status of the endpoint. Status changes are not queued and only current status is returned.

[in] hEndpoint

[out] Status—structure describing endpoint status:

struct EnpointStatus
{

| | |
|---|---|
| bool bEndpointWorking; | // true if endpoint is working |
| bool bPushSystemWorking; | // true if any of the channels are working |
| FailureReason Reason; | // set when bEndpointWorking is false |
| time LastMessageTimestamp; | |

};
enum FailureReason
{

| | |
|---|---|
| Invalid, | // endpoint hasn't received initial message w/o specified |

timeframe

| Inactive, | // endpoint was inactive for longer than specified timeframe |
|---|---|
| Disconnected,// device lost channel connectivity and thus can't reach gateway | |
| Deleted | // gateway doesn't recognize the endpoint |

};

What is claimed is:

1. A system for end-to-end validation in a push environment including a service sending messages to a gateway for delivery to a mobile computing device, said system comprising:
a memory area for storing data defining a communication path between the mobile computing device and the service, said mobile computing device configured to receive messages from the service via the gateway; and
a processor programmed to:
receive a request from an application to register an application endpoint, said application executing on the mobile computing device;
register the application endpoint with the gateway responsive to the received request, wherein the gateway defines an inactivity timeout value for the application endpoint, wherein the gateway monitors the communication path, and wherein the application subscribes the application endpoint to receive the messages from the service;
subsequently receive a notification from the gateway when the inactivity timeout value expires based on the monitored communication path; and
notify the application of the received notification, wherein the application re-registers the application endpoint with the gateway and re-subscribes with the service to receive the messages.

2. The system of claim 1, wherein the processor is further configured to:
receive the inactivity timeout value from the application for the application endpoint; and
provide the received inactivity timeout value to the gateway.

3. The system of claim 1, wherein the processor is configured to register the application endpoint by:
identifying one or more channels available for communication;
selecting one of the identified channels;
defining an object for the selected channel; and
providing the defined object to the application;

4. The system of claim 3, wherein the processor is configured to select said one of the identified channels based on one or more policy settings for the application.

5. The system of claim 1, wherein the processor is further configured to receive a uniform resource locator from the gateway for the application endpoint.

6. The system of claim 1, wherein the inactivity timeout value represents a maximum time in seconds between receipt of messages from the service.

7. The system of claim 1, wherein the processor is further configured to de-register the application endpoint responsive to the received notification from the gateway.

8. The system of claim 1, further comprising means for identifying a communication failure based on the inactivity timeout value.

9. The system of claim 1, further comprising means for re-establishing the communication path responsive to expiration of the inactivity timeout value.

10. A method comprising:
receiving a request from an application to register an application endpoint, said application executing on a computing device, said computing device configured to receive messages from a service via a gateway;
registering the application endpoint with the gateway responsive to the received request, wherein the gateway defines a registration timeout value, and wherein the application subscribes the application endpoint to receive the messages from the service;
calculating, relative to a current time, an elapsed time since said receiving; and
notifying the application of a timeout condition when the calculated elapsed time exceeds the registration timeout value without one of the messages being received from the service, wherein the application re-registers the application endpoint and re-subscribes with the service responsive to said notifying to receive the messages.

11. The method of claim 10, wherein the gateway defines the registration timeout value as a maximum time in seconds for a message to arrive at the application endpoint after said receiving.

12. The method of claim 10, further comprising receiving a request from the application to register the application endpoint with another gateway responsive to the notification of a timeout condition.

13. The method of claim 10, wherein a unidirectional message flow exists from the service to the gateway to the computing device.

14. The method of claim 10, further comprising de-registering the application endpoint with the gateway responsive to said notifying.

15. The method of claim 10, wherein the application unsubscribes from the service responsive to said notifying.

16. One or more computer-readable media having computer-executable components, said components comprising:
a communication component for interfacing between a computing device and a gateway, said computing device configured to receive messages from a service via the gateway;
a registration component for registering an application endpoint with the gateway, said application endpoint being associated with an application executing on the computing device, wherein the application subscribes with the service to receive the messages;
a timeout component for monitoring the registration by the registration component, wherein the timeout component notifies the application of a timeout condition after a predefined period of inactivity responsive to the registering by the registration component; and
an inactivity component for receiving notice of inactivity from the gateway after expiration of an inactivity timeout value maintained by the gateway, wherein the inactivity component notifies the application of the inactivity responsive to the received notice of inactivity.

17. The computer-readable media of claim 16, wherein the application re-registers the application endpoint and re-subscribes with the service responsive to the notification from the inactivity component.

18. The computer-readable media of claim 16, wherein a unidirectional message flow exists from the service to the gateway to the computing device.

19. The computer-readable media of claim 16, wherein the application endpoint comprises a uniform resource locator referencing the application.

20. The computer-readable media of claim 16, wherein the application communicates with the service outside of the gateway to subscribe to the messages.
